(19) United States
(12) Patent Application Publication
(10) Pub. No.: US 2008/0120122 A1
(43) Pub. Date: May 22, 2008

(54) Field site data gathering and reporting system and method

(76) Inventors: Jon Olenski, Chicago, IL (US); Christopher Dietzler, Chicago, IL (US)

Correspondence Address: EPSTEIN BECKER & GREEN, P.C., 150 North Michigan Avenue, 35th Floor, Chicago, IL, 60601, US

(21) Appl. No.: 11/602,070

(22) Filed: Nov. 20, 2006

(51) Int. Cl. G06Q 99/00

(52) U.S. Cl. 705/1

(57) ABSTRACT

A system and method of reporting and displaying field survey data related to particular features located at remote sites that includes generating GPS data related to a feature with a handheld device, generating at least one image of the location, entering text data related to the location on the handheld device, and uploading the GPS data, image and text data into a database located at a central location. The photograph can be optionally transferred wirelessly from a camera to the handheld device. In particular, the transfer can be on a wireless network (WiFi). Data can be post-processed at the database location before entry into the database. GIS maps and reports can be made from the processed data for use in a project. These maps and reports can be placed on a web server for access by authorized personnel. The maps can contain an aerial photograph of the remote sites with symbols representing features overlaid on the aerial photograph. Each feature on the map can be linked to the GPS data, image data and text data related to that feature.

### BACKGROUND

1. Field of the Invention

The present invention relates generally to remote data gathering and coordination, and more particularly to a field site data gathering and reporting system and method that coordinates and combines data gathered on a plurality of different field features and allows presentation of that data in map format in conjunction with images.

2. Description of the Prior Art

Surveys of electrical power distribution network sites and other remote field sites usually involve several field engineers making one or more personal visits to a site location, logging certain data, taking photographs and then returning to their office with the data in different forms. The data may be subsequently entered into a database to produce maps or reports.

In the utility industry, construction or creation of new services, or moving or changing of old services is particularly site intensive. Each pole, transformer, feeder, and route must be surveyed and located. Rights of way must be established; permits must be obtained, and finally the actual construction or change must take place. Engineering personnel must personally visit many different remote field sites, where each site can contain numerous different features and assets. It is very difficult to collect and keep track of all the separate data that is required for a project or to manage multiple projects.

Prior art methods used notebooks, and later laptop computers, PDAs and other devices to collect data. Exact location data was collected with discrete GPS equipment with coordinates later refined using methods similar to differential GPS and others. Photographs taken on film or digitally had to be coordinated with the GPS and text data concerning each site. Prior art methods, even with PDAs, led to huge sets of unrelated data that later had to be cataloged and entered into a database concerning a project.

It would be advantageous to have a system and method to take field data concerning features at remote sites with a handheld unit that can be used to both take GPS location data and to enter textual information about the site. A digital camera could take digital photographs of features and then download the image to the handheld if it is a separate unit. Heights and other measurements as well as voice reports and text data could be combined with GPS location data for each feature. At a central or home facility, uploads can be made from the handheld units, the data can be processed and checked and then entered into a database. Data from the database could be used to overlay maps or aerial photographs with unique identifiers for each feature where individual data for each feature could be retrieved for analysis.

### SUMMARY OF THE INVENTION

The present invention relates to a system and method for delivering project data that improves the overall schedule and reduces costs. The system of the present invention utilizes GPS as well as Geographic Information System (GIS) technology to provide significant improvements over prior art methods. The present invention involves the use of handheld GPS devices to field collect survey information, especially information relating to the utility industry. The GPS handheld devices can collect location data, digital photographs that can be auto-linked to the data that is captured as well as text and menu data concerning features. Field captured data can be uploaded and further processed and then linked into a GIS system that allows for quick output of overhead visual maps with aerial photography for reference. Customized reports with feature attribute data and the associated digital picture provides a powerful tool for the planning and design process. A project-specific website can be built to serve as an easily accessible repository for the reports and maps as well as other vital project-related data. Engineers and designers can update and edit field data and can access and further analyze the reports and maps in a central office. This eliminates costly field visits without compromising quality.

The present invention allows gathering and reporting field survey data captured at a remote field site concerning features and assets located at such sites, including GPS data related to the location of the asset, one or more images of the feature or asset and text data related to the feature. Photographs or other images of a feature can be transferred wirelessly from a digital camera to the handheld device on a wireless network (WiFi) or by using Bluetooth, or a camera can be integrated with the GPS handheld device. In some embodiments of the present invention recorded voice data can also be entered.

Field survey data captured on the handheld device for various features and from various locations can be uploaded into a database at a home or central office location. The data can be post-processed before entry into a project database to assure correctness and to increase accuracy. In particular, GPS data can be made more accurate using differential GPS techniques known in the art, and the field data can be put into forms more convenient for database entry and the GIS system. Aerial photographs can be overlaid with data concerning features and construction to produce convenient overhead maps. Each project feature overlaid on the aerial photograph or map can have a unique identifier and can be auto-linked to the field data and image for that feature. When an engineer wants to retrieve all the data about a particular feature, all that is necessary is to enter its unique identifier and receive back the text data, image data, GPS coordinates, measurements and comments taken in the survey of that feature. In addition to overlaid maps or aerial photographs, reports can be produced relating to all or parts of the project to any level of detail required.

### DESCRIPTION OF THE FIGURES

These and other features, objects and advantages of the present invention will become apparent from the following description and drawings wherein like reference numerals represent like elements in several views, and in which:

FIG. 1 shows an embodiment of the present invention with a two man engineering crew taking data at a remote field site.

FIGS. 2-5 show depictions of menus on a handheld device that can be used to take both GPS and text data.

FIG. 6 shows a sample data set for a transformer feature along with an image of the feature.

FIG. 7 shows a sample data set for power line poles with transformers on the poles along with an image of the feature.

FIGS. 8-11 show the flow of data through various parts of the system.

FIG. 12A shows a GIS map with an aerial photograph of a part of a particular project location overlaid with features, feature identifiers and legends.

FIG. 12B shows an enlargement of a group of features from FIG. 12A.

FIG. 12C shows an enlargement of the legend from FIG. 12A.

Several drawings and illustrations have been presented to aid in understanding the present invention. The scope of the present invention is not limited to what is shown in the figures.

### DESCRIPTION OF THE INVENTION

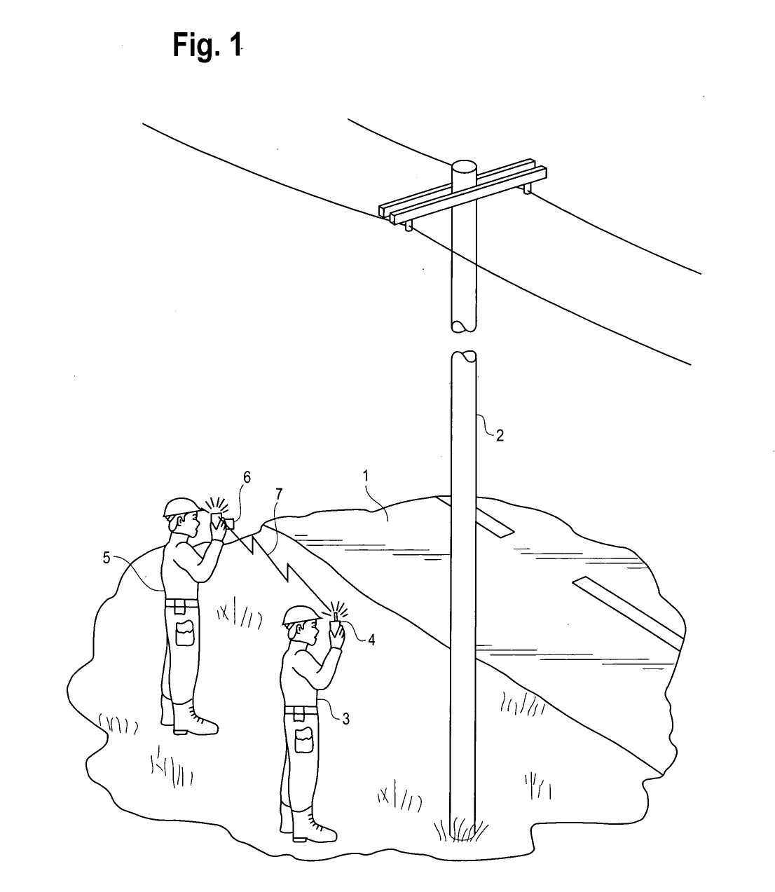

Remote field site data collection generally involves one or more engineers visiting the location and taking data. The data can be conveniently entered into a handheld device. FIG. 1 shows two field engineers 3, 5 taking a survey at the base of a power pole 2. The first engineer 3 holds a handheld unit 4 that can contain a GPS receiver and a processor with a user interface in the form of keys and a display screen. The second engineer 5 holds a digital camera 6 that can be used to photograph the feature (in this case the pole). The camera 6 can be equipped with wireless capability such as WiFi or Bluetooth so that it can transfer digital images to the handheld unit 4 using a wireless channel 7. This channel can be any form of wireless including radio and light. Common channels known in the art are infrared light, Bluetooth, cellular telephone and WiFi. In the case of cellular telephone and WiFi, the communication can be transferred indirectly through a base station or wireless hub or through the internet. In an alternate embodiment of the present invention, the camera can be contained in the handheld unit itself as an integral unit. In this case, communication between the camera and the other circuitry in the handheld unit can be by hard wire.

To use the present invention to take field data, the first engineer 3 would normally take a GPS reading on the handheld device 4 locating the site in a coordinate system such as longitude and latitude, Easting/Northing, map coordinates, range-township coordinates or by any other location coordinates. For utility work, Easting/Northing is preferred. The first engineer 3 could then have a second engineer 5 take one or more photographs of the site and transfer the image(s) to the handheld wirelessly (or alternatively the first engineer could take both the GPS data and the photograph). Finally, the first engineer 3 could enter any necessary text data concerning the site. The entry of text data can be from menus or freeform. Any method of entering data, and any type of data, is within the scope of the present invention including data selected from a menu or comments. The data in the handheld device 4 can be maintained in the device memory until uploading is convenient such as when the crew returns to the home office, or in particular embodiments of the invention, it can be uploaded immediately by cellular telephone or over the internet through a local area network or cellular telephone internet connection.

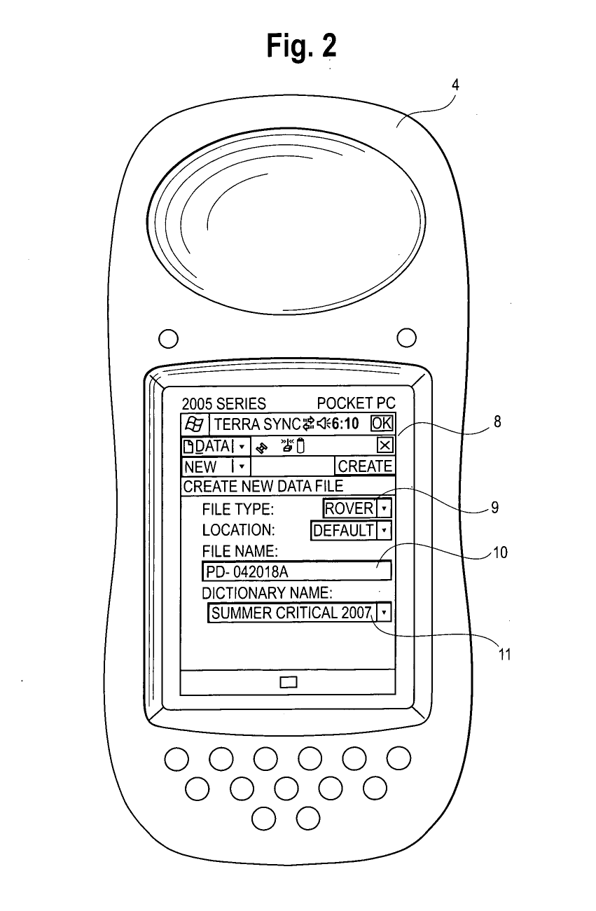

Turning to FIG. 2, a depiction of a generic version of a handheld unit 4 is seen. A preferred handheld device 4 is the Trimble GeoXH GPS unit manufactured by Trimble Navigation Ltd., of Sunnyvale Calif. that also contains a processor that can be programmed to perform specific tasks. A menu can be seen on a display 8. The Trimble device can be programmed to present this menu. This menu can be brought up by clicking a start menu icon or key to begin execution of the software. In this menu, an engineer can select to enter new data or can edit old data. In particular, the engineer can create a new data file. A file type 9 (in this case “Rover”), file or project name (“PD-042018A”) 10 and dictionary or database name (“Summer Critical 2007”) 11 can be entered. The dictionary name can refer to a project or series of projects in a master database. Generally, the engineer can take a GPS reading on the unit at any time during the operation. To do this, at least 3 satellites must be locked into the GPS receiver as is known in the art, with 4 satellites being preferred. In addition to location and photograph data, distances, heights and range data can be taken using laser or other range finder. A preferred laser device is the TruPulse™ 200 manufactured by Laser Technology, Inc. of Norristown Pa. The laser range finder can communicate with the handheld unit using Bluetooth or other wireless techniques in a manner similar to the camera.

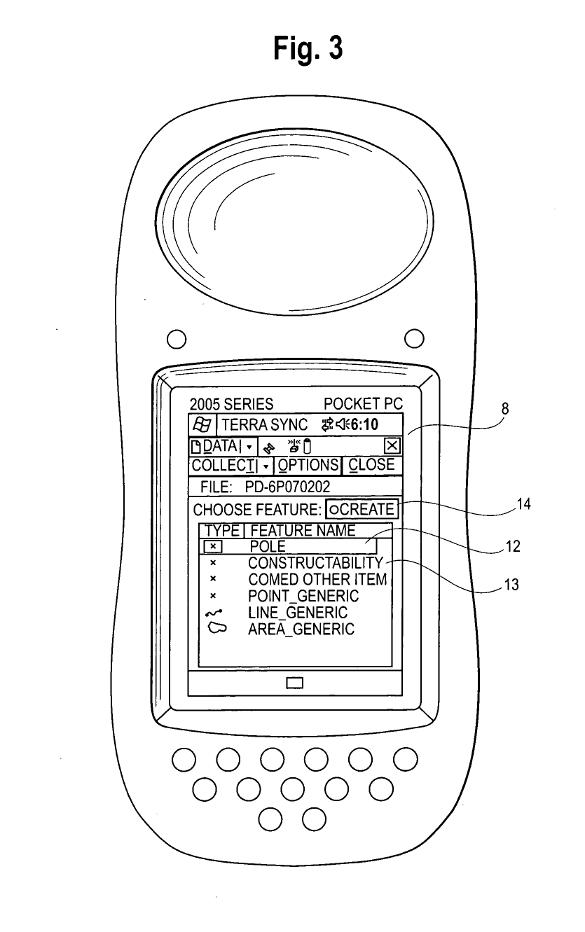

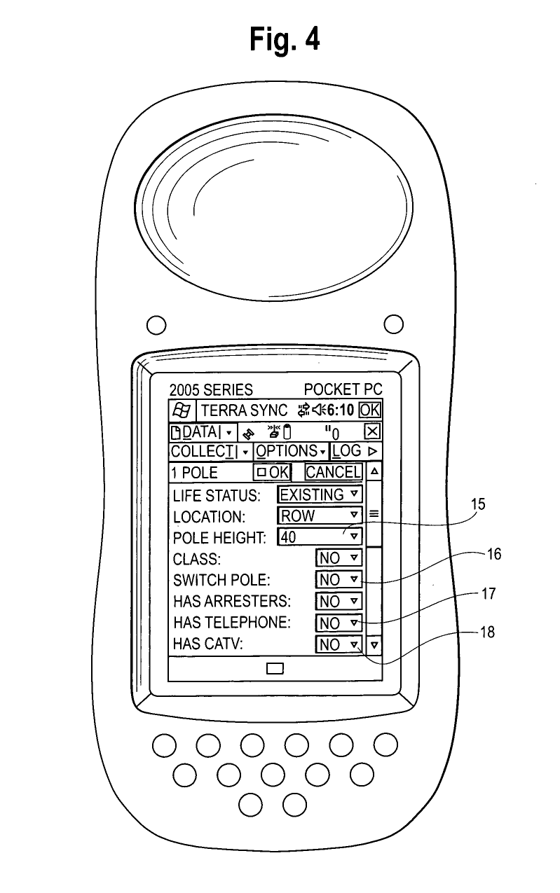

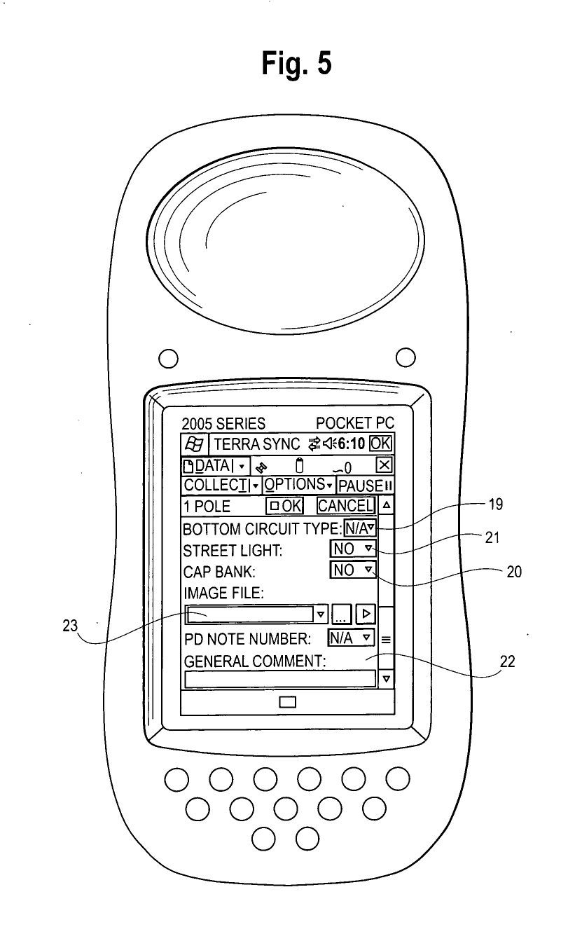

FIG. 3 shows another screen or menu 8 where the engineer can begin to enter site feature data such as whether there is a pole 12, constructability 13 etc. by activating an icon 14. FIG. 4 shows more possible features that the engineer can enter such as pole height 15, type of pole 16, auxiliary services on the pole like telephone 17 and CATV 18. FIG. 5 shows a menu that allows entry about circuit type 19, capacitor banks 20 and whether the pole has street lights 21 and other data.

At the bottom of FIG. 5, there is a location for a general comment 22 and an image file name 23. The image file can contain a digital image of the site taken by the camera 6. A preferred camera for taking field site digital photographs is the Caplio G3 digital camera manufactured by Ricoh Company Ltd. of Yokohama Japan; however, any digital camera may be used and is within the scope of the present invention. If the camera is separated from the handheld unit, it should also have wireless capability such as WiFi or Bluetooth.

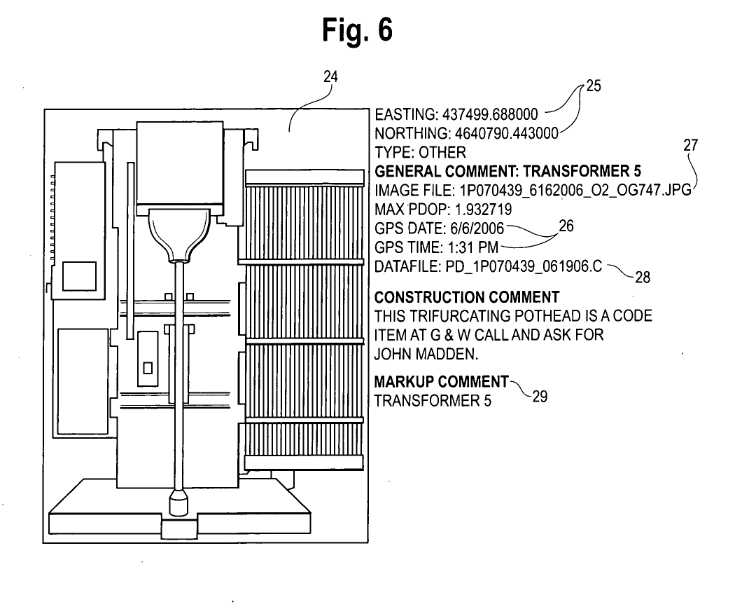

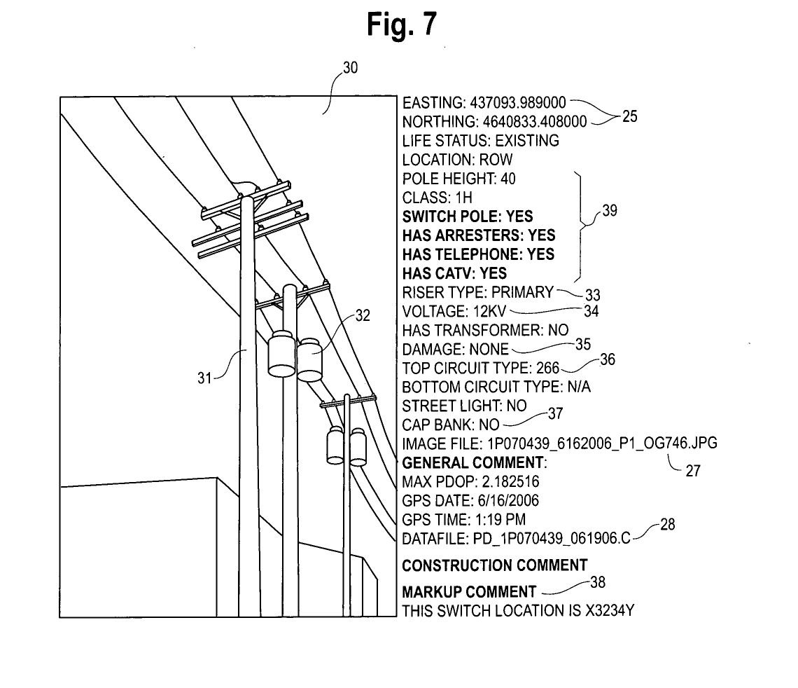

FIG. 6 shows the data captured at a particular transformer site. A photograph or image of the transformer 24 appears along with coordinate GPS data (Easting and Northing) 25, GPS time and date 26, image file 27, data file 28 and other comments 29. FIG. 7 shows a similar image 30 of another site—a set of power poles 31 with transformers 32. The data shows that the poles have primary risers 33, 12 KV voltage 34, no damage 35, particular circuit type 36, no capacitor bank 37, and general comments 38 along with GPS data 25 and an image file 27 and data file 28. In addition, there is general information 39 as to whether the site is a switch pole, has arresters and whether there is telephone and/or CATV.

After data is entered into the handheld unit, it can later be uploaded or transmitted to a home site or central office database. This uploading can be done locally by direct connection or local wireless, or it can be done remotely via the internet or cellular telephone system. Before data is entered into the database, it can be post-processed. A particular type of post-processing called differential GPS processing greatly increases the accuracy of GPS. This can be done to improve the accuracy of the location coordinates before they are entered in the project database. In addition other processing can be performed such as formatting the data into a more convenient form for storage such as a Access file or XML file. Any type of post-processing is within the scope of the present invention.

Normally once the field collection process has ended, the field utility engineer can bring the handheld unit back to an engineering office. The data can be extracted from the handheld unit and uploaded, as previously described, into a database such as an SQL or similar database. A typical type of database in the utility industry might be a summer critical database. After uploaded raw data is post-processed and put into a correct form, it can be entered into the standard enterprise database using software like SQL Server sold by Microsoft Corporation. In a particular embodiment of the invention, the data is transferred from the handheld unit to a main workstation via uploading software like MS Active Sync also sold by Microsoft Corporation. The data in this embodiment is in a file format known in the art as a .ssf file. The .ssf file then is entered into a set of application programs that perform GPS differential correction. The data can then be converted to a Microsoft Access database format for easier manipulation and conversion to Microsoft SQL Server. Various software components that verify that the data is correct can be run before it is entered into the database. Once the data is in the database, analysts can create maps and reports for the project. Examples of reports include vegetation reports, work location reports, constructability reports, manhole reports and any other types of reports required for the project.

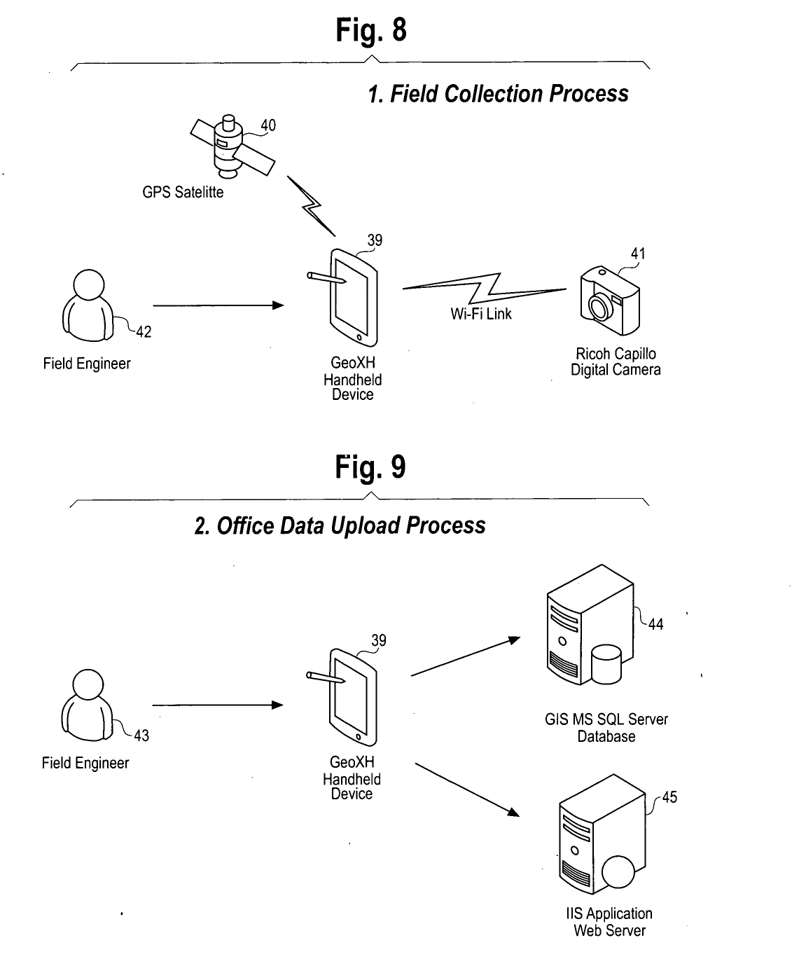

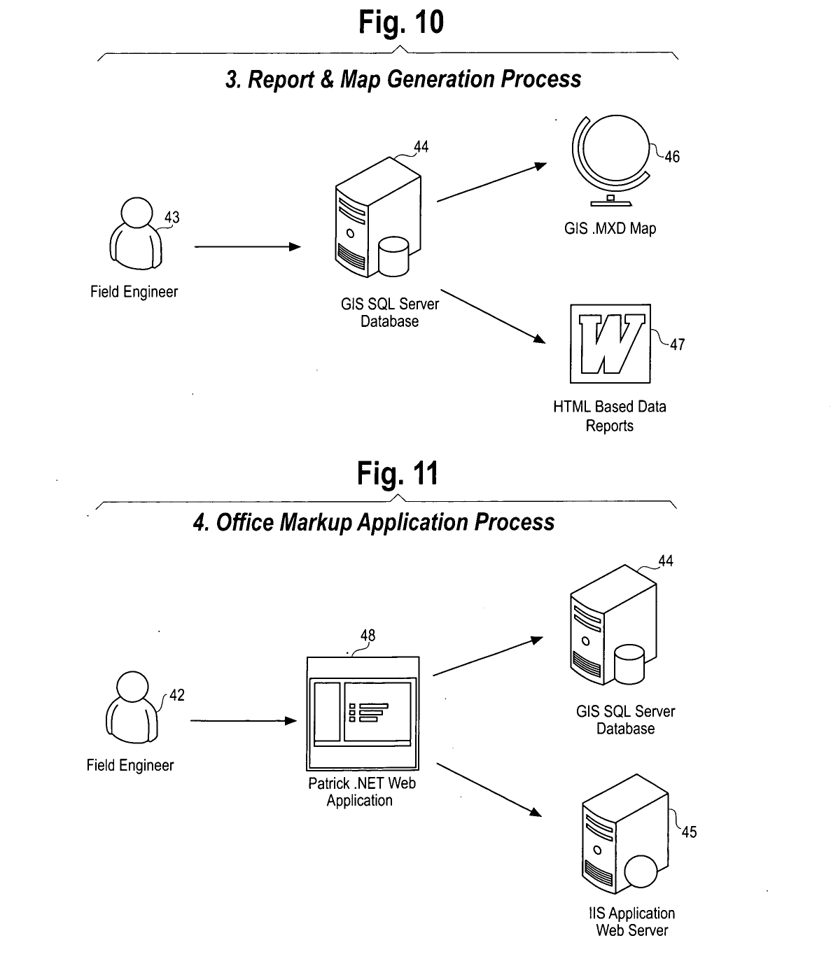

FIG. 8 shows a flow diagram of the field collection process. A field engineer 42, GPS satellite 40 data and digital photographs from a camera 41 all enter a handheld device 39 as has been previously described. The field engineer 42 can also enter text and other data into the handheld 39 as has been described. The handheld unit 39 can later be returned to a central site as shown in FIG. 9 where a GIS analyst 43 causes the handheld unit 39 to upload data to both an SQL database server 44 and to an application web server 45. The data can be entered into the database in a way that meaningful results can be retrieved. Data can also be placed on the web application server 45 so that it can be used by various applications and made available to authorized users over the internet. After the data is stored in the SQL database, it can be used to produce maps and reports as shown in FIG. 10. An analyst 43 can run various applications such as GIS software to cause the SQL server 44 to produce maps 46 in formats that are useful to the project, and to produce HTML and other language-based data reports 47 primarily for access and distribution over the internet. FIG. 11 shows a field engineer 42 using application programs 48 that run on the servers or other computers to markup and modify or change the form of the data both in the SQL database on the SQL server 44 or on the web server 45.

The data import process at the central office can be designed to read a set of raw data from a Microsoft Access Geodatabase or other database from a handheld device and write that data into Microsoft SQL Server database. The data can be transferred from the handheld unit (a GeoXH device for example) to a main workstation via an application like MS Active Sync sold by Microsoft Corporation of Redmond Wash. as previously stated. The raw data can be post-processed to improve accuracy. For each type of asset or feature: Pole, Utility Company Other, Constructability, Manhole, etc., a data record and the available fields/columns (attribute) can be read from the Microsoft Access Geodatabase and written into the SQL database. There can be a single table in the SQL database for each type of asset. During the retrieval and subsequent writing of a record, an image file (if available) can be copied to a set file location on the server machine and then renamed. Some features might have multiple image files, labeled north, south, east and west or otherwise. For features with multiple images each image can be copied and then renamed on the server file system. For each record written to the database an auto or manually generated identification number can be applied to the feature. Optionally, an additional complex identification number that includes reference to a PD number and year, month, day, hour, minute and second the record can be associated with the feature and written into the database.

After all of the field data has been entered into the database, the GIS map generation process can begin. An example of GIS software that can be modified to be used in the present invention is that manufactured by ESRI Corp. of Redlands California. Using X and Y coordinates gathered in the field, the modified GIS program can accurately display the collected data by producing overlays onto regional maps or aerial photographs. An initial map book can be created after the features are uploaded from the field units. A map book can be a series of 11″×17″, or other size, maps encompassing an entire project area. The maps can be divided into sections with 1″=100′ or other scales. Engineers can then use these section maps with features overlaid to determine routes, work locations, new pole spans, and other proposed features. The maps are particularly valuable to assist engineers to work around right of way and constructability issues like clearance, transportation issues, tree trimming, existing utilities like gas, water and cable and other issues. Various software tools can be used with the GIS system to use the map data to make various measurements such as distances and span lengths and to add features such as proposed poles, splice pits and other proposed features.

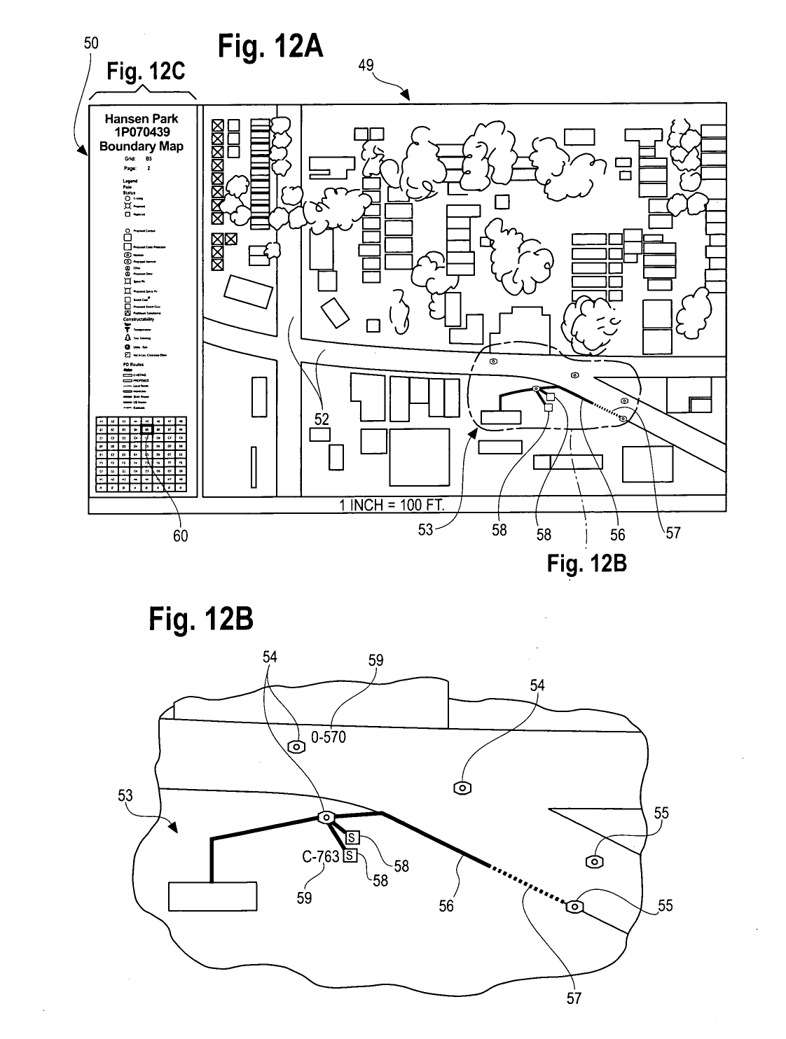

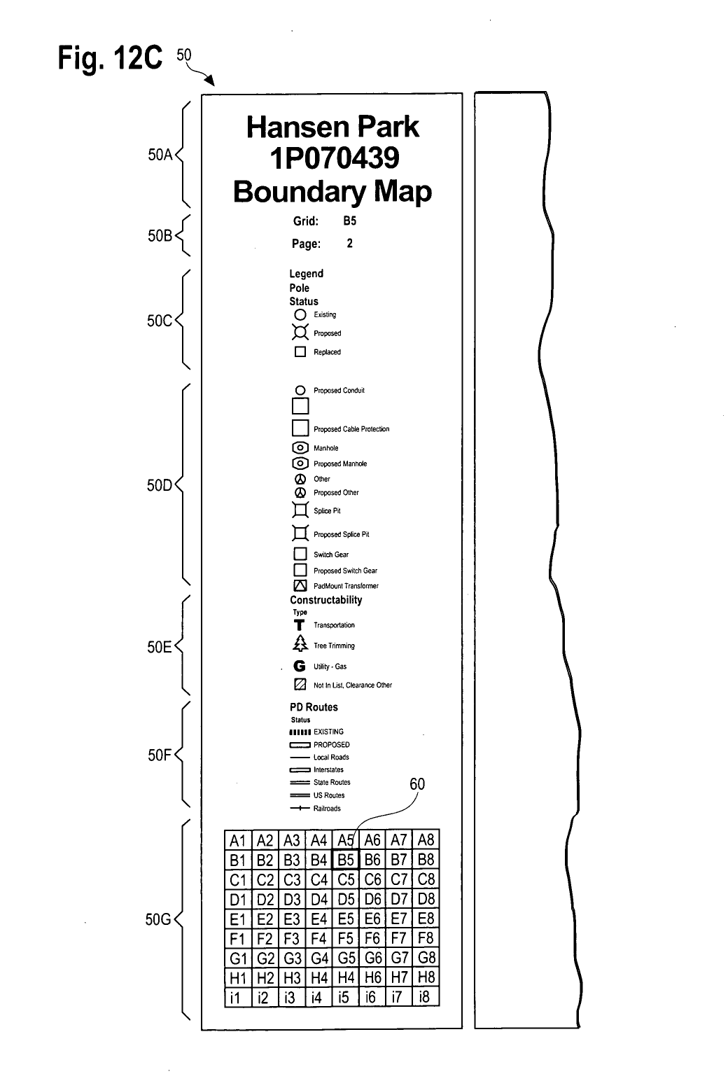

FIG. 12A shows an example of a GIS map using an aerial photograph 49 of a particular section of a project. The map also contains a legend 50 on the left. The legend relates to particular overlaid features and to what section it represents. The aerial photograph shows buildings and roads and displays a standard scale of 1″=100′. Features such as manholes 54, splice pits 58, poles 55, existing routes, 56, and proposed routes 57. FIG. 12B shows a blowup 53 of a region of the map of FIG. 12A. The features just described can be seen in detail. Different line types or colors can be used to differentiate between existing features like routes 56 and proposed features 57. The entire aerial photograph with the overlays can be presented in color or black and white. Alternatively, a map could be used instead of an aerial photograph.

FIG. 12C shows the legend 50 that can be used to identify feature types. This legend can be divided into groups of symbols. At the top, in the first group 50A, the section name “Hansen Park” can be seen. Next, a project identifier “1P070439” and a title like “Boundary Map” appear. These identify the project and the section. Moving downward, the second group 50B gives the grid number and page. Below that, appear various legend symbols 50C-50F. The first group of symbols 50C in this example relate to poles. These can be existing, proposed or replaced poles which are represented by circles or simple boxes in this example. The next group of symbols 50D relate other types of features such as conduits, cable, manholes, splice pits, switch gear, transformers and other utility features. The next group of symbols 50E relate to constructability issues like transportation, tree trimming, other utilities like gas or water and others. The final group of symbols 50F relate to routes and roads. There can be symbols for existing routes, proposed routes, roads, intersections and railroads.

At the bottom of the legend 50 there is a section identification block 50G. This block shows the relative location of all the sections with the active section 61 (the section represented by this map) outlined. FIGS. 12A-12C are examples of types of GIS maps that can be produced by the present invention. Any type of legend, location of the legend, and any choice of symbols and any manner of overlay is within the scope of the present invention.

In FIG. 12A, it can be clearly seen that each feature has a unique identifier 59. This identifier can be used to link to the feature data from the database for that feature such as the pole shown in FIG. 7 or the transformer shown in FIG. 6. The link can be generated automatically or manually. When a designer enters or clicks on the unique identifier for a feature or its symbol, all of the field and later entered office data about that feature can be viewed. In particular, the photographs taken in the field can be seen.

Other tools can be used with the maps such as that shown in FIG. 12A. In particular, by using feature identifiers, distance can be computed between two features. This is done by retrieving the GPS coordinates of the features from the database and computing a linear distance using methods known in the art. Still other tools can produce reports from the data for any purpose required such as project reports and work location reports and can allow editing of the database. As an example of this editing process, an engineer might want to change an attribute of a feature like the height of a proposed pole. Editing tools provide the capability of modifying or editing most database entries.

While the preferred embodiments of the present invention have been illustrated and described, it will be understood by those of ordinary skill in the art that changes and other modifications can be made without departing from the invention in its broader aspects. Various features of the present invention are set forth in the following claims.

1. A method for reporting field site survey data collected at a remote location, comprising:
generating at the remote location GPS data related to the remote location with a handheld device and inputting the GPS data into a device memory;
generating at the remote location photographic data related to the remote location and inputting the photographic data into the device memory;
entering at the remote location text data related to the remote location on the handheld device and inputting the text data into the device memory;
transmitting the GPS data, the photographic data and the text data from the handheld device into a central station database; and;
processing the GPS data, the photographic data and the text data to generate a display representing the remote location.

2. The method of claim 1, further comprising transferring the photograph from a camera to the handheld device wirelessly.

3. The method of claim 2 wherein the transferring wirelessly is performed using WiFi.

4. The method of claim 2 wherein the transferring wirelessly is performed using Bluetooth.

5. The method of claim 1, further comprising post-processing the GPS data before it is entered into the database to increase accuracy.

6. The method of claim 5 wherein the processing includes differential GPS processing.

7. A system for reporting field site survey data, comprising:
a handheld unit adapted to generate and store at a field site, GPS location data related to the field site, wherein the handheld unit also allows entry and storage of text data related to the field site;
a camera in communication with the handheld unit, the camera adapted to photograph the field site and transfer a photograph to the handheld unit;
a database located at a central office;
wherein, the handheld unit transmits the GPS data, the photograph and the text data to the database; and,
a computer located at the central office executing a program that combines GIS data related to the field site with the GPS data, the photograph and the text data to create a display representing the field site.

8. The system of claim 7 wherein the camera transfers the photograph to the handheld unit wirelessly.

9. The system of claim 8 wherein the wireless transfer is via WiFi.

10. The system of claim 8 wherein the wireless transfer is via Bluetooth.

11. The system of claim 7 wherein the computer at the central office processes the GPS location data using differential GPS before entry into the database.

12. The system of claim 7 wherein the display contains an aerial photograph including overlaid information related to the field site.

13. The system of claim 7 wherein information overlaid on the aerial photograph is auto-linked to the GPS data, the photograph and the text data related to the field site.

14. A method for reporting and presenting data from a plurality of field sites, comprising:
remotely collecting coordinate location data, text data and photographic data related to a particular feature at one of the field sites;
assigning a unique feature identifier to the particular feature;
storing the coordinate location data, the text data and the photographic data in a database located at a central location according to the unique feature identifier;
producing a map displaying at least one of the plurality of field sites including a symbol representing the particular feature along with the unique feature identifier; and
linking the feature on the map to the location data, the text data and the photographic data.

15. The method of claim 14 wherein the map is an aerial photograph.

16. The method of claim 14 wherein the symbol has a shape related to feature type.

17. The method of claim 14 wherein the map displays a plurality of features.

18. The method of claim 17, further comprising measuring a distance between two of the features using coordinate location data stored in the database for each of the features.

19. A method of reporting field survey data collected at a remote location wherein the field survey data comprises GPS data, image data and text data, the method comprising:
identifying a remote location site component;
generating at the remote location GPS data related to the site component using a handheld device and storing the GPS data in a device memory;
generating at the remote location image data related to the site component and storing the image data in the device memory;
generating at the remote location text data related to the site component and storing the text data in the device memory;
transmitting the field survey data related to the site component from the device memory to a central station database;
assigning an identifier to the site component and its associated field survey data; and
generating a remote location visual display including a representation of one or more site components and its associated identifier.

20. The method of claim 19 wherein the visual display also includes visual indicia of one or more of the GPS data, image data or text data associated with the one or more site components.

21. The method of claim 19 wherein aerial photographic data of the remote location is used in generation of the remote location visual display.

22. The method of claim 19 wherein the remote location image data is a photograph.

23. The method of claim 19 wherein the field survey data further comprises height data, the method further comprising the step of generating at the remote location height data related to the site component and storing the height data in the device memory.

24. A system for collecting and visually presenting feature data for each of a plurality of features, the features being located at a plurality of different remote field sites, comprising:
a means for generating and storing GPS data for a particular feature, the GPS data locating the particular feature in a coordinate system;
a means for generating and storing a photograph of the particular feature;
a means for generating and storing text data related to the particular feature;
a computer located at a central office containing a database;
a means for transmitting the GPS data, the photograph and the text data into the database for each of the plurality of features;
a software program running on the computer, the software program producing a visual display containing an aerial photograph showing the remote field sites;
a means for assigning a unique identifier to each of the features;
the software program overlaying symbols representing the features along with the unique identifier for each feature on the aerial photograph at coordinate locations determined by the GPS data for each feature; and
the software program providing a link between each unique identifier on the visual display and the GPS data, the photograph and the text data for the feature represented by the unique identifier.

25. The system of claim 24 wherein the GPS data is generated and stored by a handheld device.

26. The system of claim 24 wherein the photograph is generated with a camera wirelessly linked to the handheld device.

27. The system of claim 24 wherein the text data is entered into the handheld device.
